(19) United States
(12) Patent Application Publication
(10) Pub. No.: US 2003/0070276 A1
(43) Pub. Date: Apr. 17, 2003

(54) Method and apparatus for securing material to sheetmetal

(76) Inventor: Rick Raines, Lee's Summit, MO (US)

Correspondence Address: Daniel A. Crowe, Esq., Bryan Cave LLP, 211 North Broadway, Suite 3600, St. Louis, MO, 63102, US

(21) Appl. No.: 09/981,018

(22) Filed: Oct. 16, 2001

(51) Int. Cl. B23P 11/00; B21D 39/03

(52) U.S. Cl. 29/432.1; 29/505; 29/33 R

(57) ABSTRACT

A method and apparatus (20) for mechanically securing material (10), such as, for example, gasket or damping-type material for inhibiting or minimizing transfer of vibration or noise to sheetmetal (12) by punching, cutting, or otherwise creating one or more bendable metal flanges (14,16) in the sheetmetal (12) which project through and are bent or folded over and against the material (10) to thereby secure it in place. The apparatus (20) broadly comprises a punch (24) operable to create the flanges (14,16) by punching through the sheetmetal (12) , and an anvil (28) operable to bend or fold the flanges (14,16). The flanges (14,16) are preferably 1/10-½ inch in length and 1/10-¼ inch in width, and are provided with a curvature to facilitate bending.

### BACKGROUND OF THE INVENTION

1. Field of the Invention

The present invention relates to methods and apparatuses for securing material to sheetmetal. More particularly, the invention relates to a method and apparatus for mechanically securing a material, such as, for example, a gasket or damping-type material for inhibiting transfer of vibration or noise to sheetmetal by punching, cutting, or otherwise creating one or more bendable metal flanges in the sheetmetal which project through and are bent or folded over and against the material to thereby secure it in place.

2. Description of the Prior Art

It is often desirable to provide a material adjacent a portion of sheetmetal, and often further desirable to secure the material to the sheetmetal in order to prevent inadvertent disassociation therebetween. This is true, for example, in the automotive arts where various materials, such as, for example, gasket or damping-type materials are often used in conjunction with sheetmetal in order to minimize or inhibit transfer of vibration or noise.

Various means of securing the material to the sheetmetal are known in the art. Glue bonding, for example, is known whereby a glue or other chemical bonding agent used to secure the two together. Unfortunately, glue bonding can be wastefully messy, difficult to clean up, and may require relatively long set-up times. Another known means of securement involves stapling, pop-rivets, screws, or other mechanical fastening means. Unfortunately, the application of such fasteners is time consuming, and some thin materials are prone to tear away from standard fasteners, particularly thin wire staples. Furthermore, if the fastener is incorrectly applied, it may protrude and snag. Yet another known means of securement involves heat staking, whereby the material is melted to the sheetmetal. Unfortunately, heat staking is expensive and can involve dangerously high temperatures.

Due to the above-identified and other limitations and disadvantages of the current art, a need exists for an improved mechanism for securing material to sheetmetal.

### SUMMARY OF THE INVENTION

The present invention solves the above-described and other problems and provides a distinct advance in the art of securing material to sheetmetal. More particularly, the present invention provides a simple, inexpensive, and effective method and apparatus for mechanically securing a material, such as, for example, a gasket or damping-type material for inhibiting transfer of vibration or noise, to sheetmetal by punching, cutting, or otherwise creating one or more bendable metal flanges in the sheetmetal which project through and are bent or folded over and against the material to thereby secure it in place.

In a preferred embodiment, the method broadly involves positioning the material adjacent the sheetmetal; creating the one or more flanges in the sheetmetal such that they project through the material; and then bending or folding the one or more flanges over and against the material to thereby secure it in place against the sheetmetal. The flanges are preferably 1/10-½ inch in length, and between 1/10 and ¼ inch in width, and are preferably provided with a curvature to facilitate bending. The flanges may be created by punching or cutting the sheetmetal or by other similar means. Where more than one flange is created, the flanges are preferably bent or folded in different directions.

The apparatus is operable to implement the above-described method, and, in a preferred embodiment, broadly comprises a punch; a stripper; and an anvil. The punch is operable to punch through the sheetmetal to create the one or more flanges. The stripper is operable to strip the sheetmetal from the punch after the punch has punched therethrough. The anvil is operable to bend or fold the flanges over and against the material, thereby securing it in place. It will be appreciated that such an apparatus might be electrical, mechanical, hydraulic, or pneumatic in nature.

These and other features of the present invention are more fully described below in the section entitled DETAILED DESCRIPTION OF A PREFERRED EMBODIMENT.

### BRIEF DESCRIPTION OF THE DRAWING FIGURES

A preferred embodiment of the present invention is described in detail below with reference to the attached drawing figures, wherein:

FIG. 1 is an edge-on sectional view of a material and sheetmetal positioned in accordance with a first step in a preferred embodiment of the method of the present invention;

FIG. 2 is an edge-on sectional view of the material and the sheetmetal wherein two flanges have been created in accordance with a second step in the preferred embodiment of the method of the present invention;

FIG. 3 is an edge-on sectional view of the material and the sheetmetal wherein the two flanges have been bent or folded back and against the material in accordance with a third step in the preferred embodiment of the present invention;

FIG. 4 is a schematic diagram of a preferred first embodiment of an apparatus operable to implement the steps shown in FIGS. 1-3;

FIG. 5 is a schematic diagram of a preferred second embodiment of an apparatus operable to implement the steps shown in FIGS. 1-3;

FIG. 6 is a fragmentary elevation view of a preferred first embodiment of a punch portion of the apparatus;

FIG. 7 is a fragmentary elevation view of a preferred second embodiment of the punch portion of the apparatus; and

FIG. 8 is an isometric view of a preferred embodiment of an anvil portion of the apparatus.

### DETAILED DESCRIPTION OF A PREFERRED EMBODIMENT

Referring to the drawing figures, the present invention provides a method and apparatus 20 for mechanically securing a material 10 to sheetmetal 12 by creating one or more bendable metal flanges 14,16 in the sheetmetal 12 which project through and are bent or folded over and against the material 10 to thereby trap and secure it in place.

The present invention is substantially independent of any particular type of material 10 or sheetmetal 12. In automotive applications, for example, the material 10 may be any natural or synthetic gasket or damping-type material, such as rubber or felt, operable to inhibit the transfer of noise or vibration. By inhibit, what is meant is to minimize, dampen or substantially reduce the transfer of noise or vibration. Specific examples of such materials include asphalt sheets or a heat expandable material such as those described in U.S. Pat. No. 5,635,562, the contents of which are incorporated herein for all purposes. Similarly, the sheetmetal 12 may be any metal, metal-alloy, or metal composite material having physical characteristics amenable to punching and bending. Suitable metals include, for example, mild steel, galvanized steel, tin, and aluminum. The thickness of the sheetmetal 12 will impact its usability; this is particularly true for harder metals. In automotive applications, for example, mild or galvanized steel sheetmetal of between 16 and 22 gauge would be suitable for use with the present invention.

In a preferred embodiment, referring to FIGS. 1-3, the method broadly involves positioning the material 10 adjacent the sheetmetal 12; creating the one or more flanges 14 ,16 in the sheetmetal 12 such that they project through the material 10; and then bending or folding the one or more flanges 14,16 over and against the material 10 to thereby hold and secure it in place against the sheetmetal 12.

Referring particularly to FIG. 1, the material 10 is positioned adjacent the sheetmetal 12 so that whatever mechanism is used to create the flanges 14,16 simultaneously causes the flanges 14,16 to penetrate and project through the material 10. In equally preferred alternative embodiments, including the one described below, the flanges 14,16 are created first, and then the material 10 is positioned adjacent the sheetmetal 12 such that the flanges 14 either protrude through pre-made holes in the material 10 or forcibly penetrate the material 10 to project therethrough.

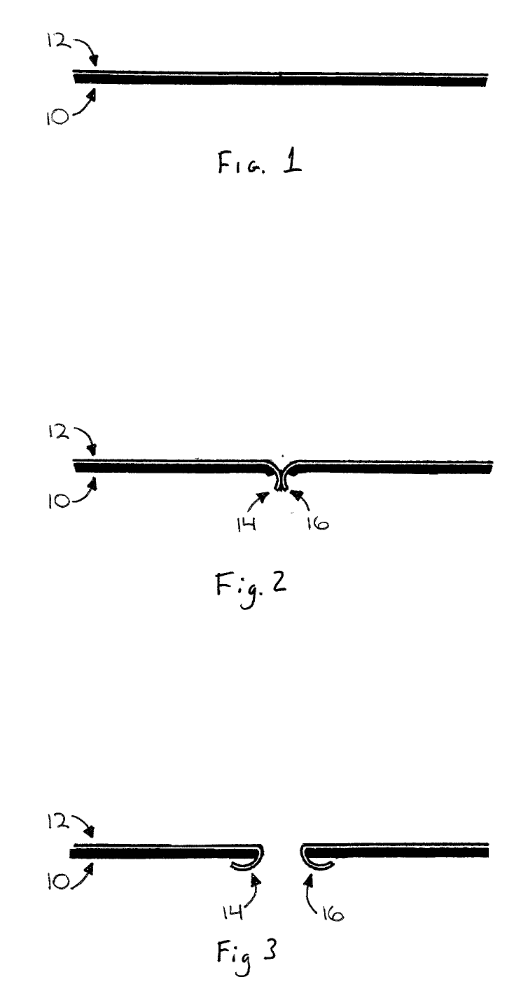

Referring particularly to FIG. 2, the flanges 14,16 may be created by punching or cutting the sheetmetal 12 or by other similar means. The manner of creation preferably results in flanges 14,16 of between approximately 1/10-½ inch long, and between approximately 1/10-¼ inch wide, and having some degree of curvature along at least a portion of that length. Such curvature preferably effectively provides an approximately 60° angle to the flanges, which, it will be appreciated, facilitates bending or folding the flanges 14,16. The flanges 14,16 are also preferably 1/10-¼ inch wide to prevent the material 10 from easily tearing away.

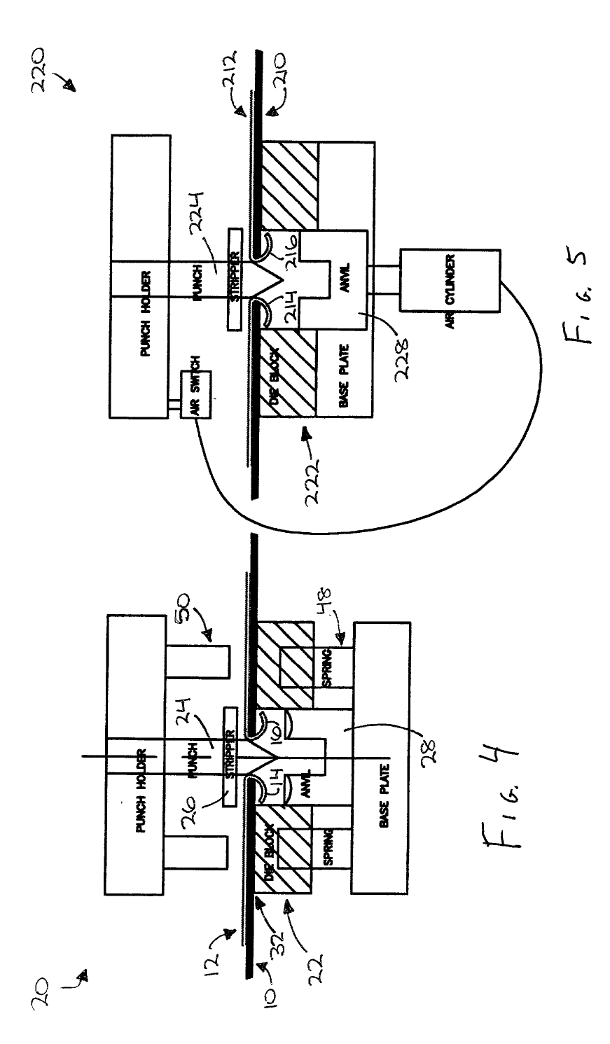

Referring particularly to FIG. 3, by bending or folding the flanges 14,16 back and against the material 10, the material 10 is trapped against and secured to the sheetmetal 12. Where two opposing flanges 14,16 are created, they are preferably bent or folded in opposite directions; where more than two flanges 14,16 are created, they are preferably bent or folded in different directions.

Alternatively, as mentioned, the material 10 may first be provided with one or more holes operable to pass the flanges 14,16. The flanges 14,16 are then created in a manner substantially similar to that described above, and the material 10 is laid over the sheetmetal 12 such that flanges 14,16 project through the pre-existing holes. As above, the flanges 14,16 are then bent or folded over and against the material 10.

Referring to FIG. 4, the apparatus 20 is operable to implement the above-described method, and broadly comprises one or more die blocks 22; a punch 24; a stripper 26; and an anvil 28. The die blocks 22 are operable to support the sheetmetal 12 and the material 10 and prevent deflection thereof during the punching process. The die blocks 22 are one or more blocks of tool steel, with each such block 22 presenting a contact surface 32 for supporting the sheetmetal 12 and the material 10. A hole must be provided in one of the die blocks 22 or the blocks 22 must be arranged so that the punch 24 may pass through the plane of the contact surface 32. The contact surface 32 may be flat or, as desired, may be contoured to accommodate a particular shape of the sheetmetal 12.

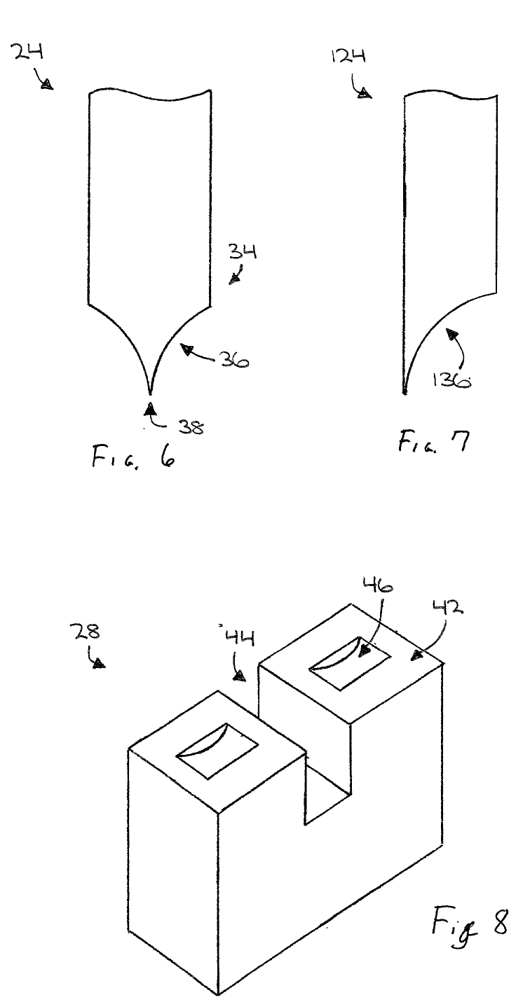

Referring also to FIG. 6, the punch 24 is an elongated piece of tool steel presenting a punch end 34 operable to punch through the sheetmetal 12 to create the one or more flanges 14,16, with each flange 14,16 being approximately 1/10-½ inch in length. The punch end 34 presents one or more punching surfaces 36 which concavedly curve into a point 38 at an effective angle of approximately 60°. The point 38 facilitates punching through the sheetmetal 12 and material 10. The concavedly curved punching surface 36 results in the flanges 14,16 having a corresponding curve which makes bending or folding the flanges 14,16 easier.

The punch 24 shown in FIG. 6, having two curved punching surfaces 36, is operable to create two opposing flanges 14,16, as shown in FIG. 4. An alternative embodiment of the punch 124 is shown in FIG. 7 having only one curved punching surface 136 and therefore operable to create only one flange 14 with each punching action. It will be appreciated that any practical number of flanges 14,16 may be created in this manner using an appropriately modified punch 24.

The stripper 26 is operable to strip the sheetmetal 12 from the punch 24 after the punch 24 has punched through the sheetmetal 12, and is further operable to provide a resistance facilitating operation of the anvil 28. The stripper 26 is preferably a substantially planar piece of tool steel oriented perpendicular to the punch 24 and having an opening (not shown) through which the punch 24 passes. After punching the sheetmetal 12, either the moveable punch 24 passes through the stripper 26 or the moveable stripper 26 is passed over the immobile punch 24; in either embodiment, the sheetmetal 12, which may have a tendency to cling to or hang upon the punch 24 is stripped therefrom.

Referring also to FIG. 8, the anvil 28 is operable to bend or fold the flanges 14,16 over and against the material, thereby securing it in place. The anvil 28 is preferably a block of tool steel having one or more contact surfaces 42 and a center recess 44. Each contact surface 42 corresponds to a newly punched flange 14,16 and preferably presents an elongated concave cup portion 46 so that when the contact surfaces 42 are brought into contact with the flanges 14,16, the flanges 14,16 enter the corresponding cup portions 46 and are thereby bent or folded to the desired degree and in the in the desired direction. As mentioned, the stripper 26 facilitates this action by providing a resistant backing which prevents the sheetmetal 12 from deflecting or otherwise moving away from the anvil 28 as the anvil 28 is brought into contact with the flanges 14,16. The recess 44 is provided to accommodate the punch end 34 which might otherwise damaged by collision with the anvil 28.

It will be appreciated that one or more of the components of the apparatus 20 must actuate, whether, for example, electrically, mechanically, hydraulically, or pneumatically, in order to accomplish the method. Thus, the apparatus 20 and its functioning may be implemented in any of a number of equivalent ways. For example, FIG. 4 shows a preferred first embodiment wherein the anvil 28 is immobile, the die blocks 22 are mounted on springs 48, and the punch 24 is actuatable. In use and operation, the sheetmetal 12 and material 10 are positioned adjacent one another such that the sheetmetal 12 faces the punch 24 and the material 10 faces the anvil 28. The punch 24 is actuated so as to pass through the hole in the stripper 24 and drive through the sheetmetal 12 and material 10, thereby creating the flanges 14,16. Immediately following such penetration by the punch 24, one or more standoffs 50 drive the sheetmetal 12, material 10, and die blocks 22 downward, thereby compressing the springs 48. As the sheetmetal 12 moves downward, the flanges 14,16 are driven into the contact surfaces 42 and into the concave cup portions 46 thereof to bend or fold the flanges 14,16 back and against the material 10. As the punch 24 is withdrawn, the stripper 26 prevents the sheetmetal 12 from being pulled therewith. As the stand-offs 50 are withdrawn, the springs 48 decompress and the die blocks 22 return to their initial position.

FIG. 5 shows one possible equally preferred second embodiment of the apparatus 220 wherein the punch 224 and anvil 228 are both actuated, but the die blocks 222 are immobile. In use and operation, the sheetmetal 212 and material 210 are positioned on the die blocks 22 as described above. In this embodiment, however, as the punch 224 is actuated to punch through the combined sheetmetal 212 and material 210, the anvil 228 is also correspondingly actuated to bend or fold the resulting flanges 214,216 back and against the material 210 to achieve the same result as the above-described preferred first embodiment.

Regardless of how the apparatus 20 is embodied, it will be appreciated that the punch 24 and anvil 28 must be applied with at least a minimum pressure in order to, respectively, penetrate the sheetmetal 12 and material 10 and bend or fold the resulting flanges 14,16. Naturally, this minimum pressure will vary depending on the nature and thickness of the sheetmetal 12 and the material 10. In an automotive application, for example, using mild or galvanized steel sheetmetal of between 18 and 20 gauge thickness, an effective pressure of approximately 80 PSI should be sufficient accomplish these functions.

From the preceding description, it will be appreciated that the present invention provides a simple, inexpensive, and effective method and apparatus for mechanically securing a material 10 to sheetmetal 12. Although the invention has been described with reference to the preferred embodiments illustrated in the attached drawing figures, it is noted that equivalents may be employed and substitutions made herein without departing from the scope of the invention as recited in the claims. For example, as noted, the order of some of the method steps may be changed as a matter of design while accomplishing substantially the same result. Furthermore, also as noted, the apparatus 20, with the components described, may function in a variety of equally preferred ways, each of which also accomplishes substantially the same result.

Having thus described the preferred embodiment of the invention, what is claimed as new and desired to be protected by Letters Patent includes the following:

1. A method of securing a material operable to inhibit the transfer of noise or vibrations to a sheetmetal, the method comprising the steps of:
(a) positioning the material adjacent the sheetmetal;
(b) creating a flange in the sheetmetal such that the flange projects through the material; and
(c) bending the flange over and against the material to thereby secure the material to the sheetmetal.

2. The method as set forth in claim 1, wherein step (b) is accomplished by punching through the sheetmetal to create the flange.

3. The method as set forth in claim 1, wherein step (b) is accomplished by cutting through the sheetmetal to create the flange.

4. The method as set forth in claim 1, wherein the flange is between 1/10 and ½ inch long, and between 1/10 and ¼ inch wide.

5. The method as set forth in claim 1, wherein step (b) includes imparting a curvature to a portion of the flange.

6. The method as set forth in claim 1, wherein the result of step (b) is the creation of two opposing flanges, and step (c) involves bending each opposing flange in an opposite direction.

7. A method of securing a material operable to inhibit the transfer of noise or vibrations to a portion of sheetmetal, the method comprising the steps of:
(a) positioning the material adjacent the sheetmetal;
(b) punching through the sheetmetal to create two or more curved flanges of between 1/10 and ½ inch in length and between 1/10 and ¼ inch in width, such that each of the two or more curved flanges projects through the material; and
(c) bending each of the two or more curved flanges in a different direction over and against the material to thereby secure the material to the sheetmetal.

8. A method of securing a material operable to inhibit the transfer of noise or vibrations to a portion of sheetmetal, the method comprising the steps of:
(a) creating a hole in the material;
(b) creating a projecting flange in the sheetmetal;
(c) positioning the material adjacent the sheetmetal such that the flange projects through the hole; and
(d) bending the flange over and against the material to thereby secure the material to the sheetmetal.

9. An apparatus for securing a material operable to inhibit the transfer of noise or vibrations to a sheetmetal, the apparatus comprising:
a punch operable to punch through the sheetmetal and the material to create a flange from the sheetmetal which projects through the material; and
an anvil operable to bend the flange over and against the material, thereby securing the material to the sheetmetal.

10. The apparatus as set forth in claim 9, wherein the apparatus is hydraulic in nature and operable to generate a pressure at the punch of between 60 and 100 PSI.

11. The apparatus as set forth in claim 9, wherein the apparatus is pneumatic in nature and operable to generate a pressure at the punch of between 60 and 100 PSI.

12. The apparatus as set forth in claim 9, wherein the punch includes an elongated piece of tool steel presenting a punch end having a concavedly curving surface tapering to a point which is operable to impart a curvature to a portion of the flange.

13. The apparatus as set forth in claim 9, wherein the anvil provides a contact surface corresponding to the flange, with the contact surface presenting an elongated concave cup operable to receive and bend the flange in a desired direction.

14. The apparatus as set forth in claim 9, further including a stripper operable to strip the sheetmetal from the punch after the punch has punched through the sheetmetal.

15. The apparatus as set forth in claim 9, further including one or more die blocks operable to support the sheetmetal and to substantially limit deflection of the sheetmetal due to operation of the punch.

16. An apparatus for securing a material operable to inhibit the transfer of noise or vibrations to a sheetmetal, the apparatus comprising:
a punch including an elongated piece of tool steel presenting an end having one or more concavedly curving surfaces tapering to a single point operable to punch through the sheetmetal and the material to create a flange which projects through the material; and
one or more die blocks operable to support the sheetmetal and to substantially limit deflection of the sheetmetal due to operation of the punch; a stripper operable to strip the sheetmetal from the punch after the punch has punched through the sheetmetal; and
an anvil providing a contact surface presenting an elongated concave cup operable to receive and bend the flange in a desired direction, thereby securing the material to the sheetmetal.

17. The apparatus as set forth in claim 16, wherein the apparatus is hydraulic in nature and operable to generate a pressure at the punch of between 60 and 100 PSI.

18. The apparatus as set forth in claim 16, wherein the apparatus is pneumatic in nature and operable to generate a pressure at the punch of between 60 and 100 PSI.
